(19) United States
(12) Patent Application Publication
(10) Pub. No.: US 2014/0160155 A1
(43) Pub. Date: Jun. 12, 2014

(54) Inserting an Object into an Image

(71) Applicants: Alexander Berkovich, Haifa (IL); Pavel Kisilev, Maalot (IL)

(72) Inventors: Alexander Berkovich, Haifa (IL); Pavel Kisilev, Maalot (IL)

(73) Assignee: HEWLETT-PACKARD DEVELOPMENT COMPANY, L.P., Houston, TX (US)

(21) Appl. No.: 14/131,517

(22) PCT Filed: Aug. 30, 2011
(86) PCT No.: PCT/US2011/049666

§ 371 Date: Jan. 8, 2014

(51) Int. Cl. G06T 11/60

(52) U.S. Cl. CPC G06T 11/60
USPC 345/629

(57) ABSTRACT

A method (10) can comprise detecting (40) a shadow for a reference object (356) in a target image (350) in response to user input marking the reference object (356). The method can also comprise forming (170) a shadow (652) for an insertion object (310) to be inserted into the target image (350) based on the detected shadow for the reference object (356). The method can further comprise inserting (180) the shadow (652) for the insertion object (31p) into the target image (350).

### BACKGROUND

Photo manipulation includes the application of image editing techniques to photographs in order to create an illusion or deception (in contrast to mere enhancement or correction), through analog or digital means. Many graphics applications are capable of merging one or more individual images into a single file. In such applications, the orientation and placement of each image can be controlled.

An object selected in an image to be merged into another image the object is typically separated at the edges of the from the object's background, in a process known as silhouetting. This is the digital version of cutting out the image. Clipping paths may be used to add silhouetted images to vector graphics or page layout files that retain vector data. Once the object is selected, the object may be copied and pasted into another section of the same file, or into a separate file.

### BRIEF DESCRIPTION OF THE DRAWINGS

FIG. 1 illustrates an example of a flowchart of a method for inserting an object from a source image into a target image.

FIG. 2 illustrates an example of a GUI to select an insertion object in a source image.

FIG. 3 illustrates an example of a target image with a reference object.

FIG. 4 illustrates an example of a flowchart of a method for detecting a shadow of a reference object.

FIG. 5 illustrates an example of an initial region of interest and its location within a target image relative to a reference object.

FIG. 6 illustrates an example of refinement of the region of interest illustrated in FIG. 5.

FIGS. 7 and 8 illustrate two different images that depict an example of a component before morphological dilation and the same component after morphological dilation.

FIG. 9 illustrates an example of an original copy of a target image.

FIG. 10 illustrates a shadow mask of the target image illustrated in FIG. 9.

FIG. 11 illustrates a zoomed in version of the bounding box illustrated in FIG. 10.

FIG. 12 illustrates an example of a shadow location computed for the reference object illustrated in FIG. 3.

FIG. 13 illustrates an example of an affine transformation of a silhouette of the insertion object selected in FIG. 2.

FIG. 14 illustrates an example of a method for inserting a shadow of an insertion object into a target image.

FIG. 15 illustrates an example of the target image illustrated in FIG. 3 with an insertion object inserted with the shadow generated for the insertion object.

FIG. 16 illustrates an example of a computer system for inserting an object into a target image.

FIG. 17 illustrates another example of a flowchart of a method for inserting an image.

### DETAILED DESCRIPTION

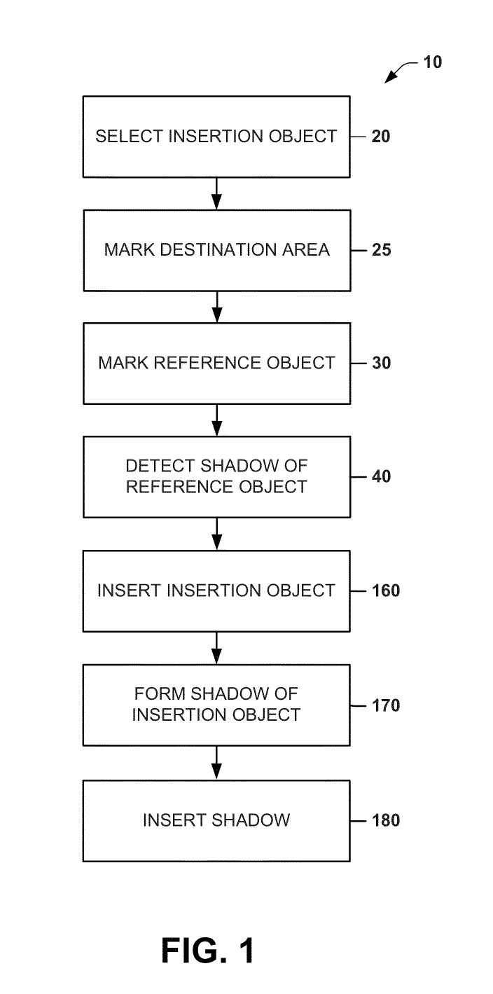

FIG. 1 illustrates an example method 10 that can be implemented for inserting an object from a source image into a target image. For example, the target and/or the source image can be implemented as an image in a Red, Blue, Green (RGB) color space, such as a Joint Photographic Experts Group (JPEG) file, a raw image format, a bitmap file or the like. It is to be noted that in some examples, the source image and the target image can be the same file.

The method 10 can be implemented, for example, by a computer. For instance, the method 10 can be embodied as machine readable instructions, such as software or firmware that can be executed by a processor. The method can also be stored in memory in a machine readable format. While, for purposes of simplicity of explanation, the method 10 of FIG. 1 is shown and described as executing serially, the method 10 is not limited by the illustrated order, as some actions could in other examples occur in different orders and/or concurrently from that shown and described herein. Additionally, where the disclosure or claims recite “a,” “an,” “a first,” or “another” element, or the equivalent thereof, it should be interpreted to include one or more than one such element, neither requiring nor excluding two or more such elements.

At 20, an object in the source image is selected for insertion into the target image, which object can be referred to as an insertion object. The selection of the insertion object can be performed by a user with a graphical user interface (GUI). In one example, the insertion object can be segmented from the background of the source image, and cut and/or copied from the source image. Thus, segmenting of the insertion object can include, for example, a selection of the boundary of the insertion object.

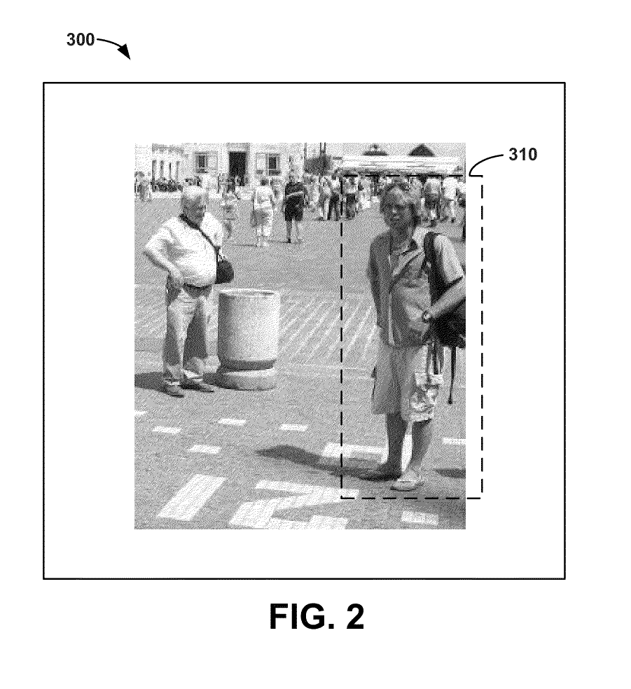

FIG. 2 illustrates an example of a GUI 300 for selecting an insertion object in a source image. In the example illustrated in FIG. 2, a person holding a backpack can be circumscribed with a boundary box 302 in response to user input. In some examples, the GUI 300 can request (e.g., via a dialog box) that the user click several times on the insertion object, and to click several times on the background of the source image to increase the likelihood that the proper insertion object is selected.

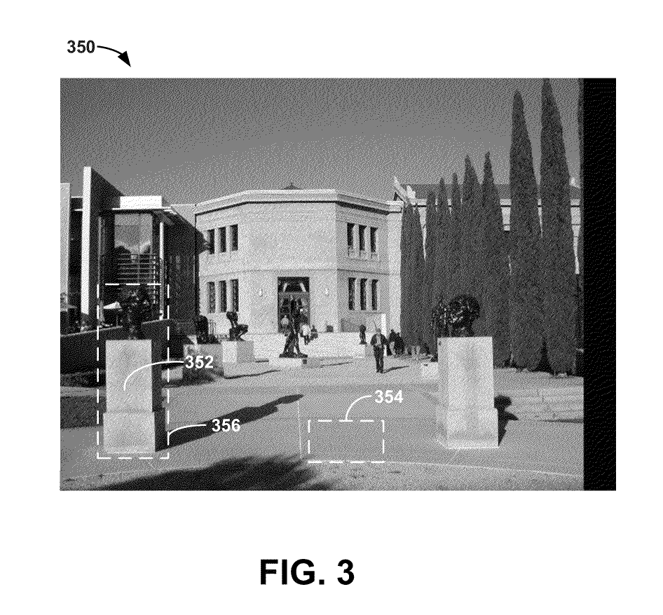

Referring back to FIG. 1, at 25, a destination area in the target image can be marked in response to user input for insertion of the insertion object, and at 30 a reference object in the target image can be marked. FIG. 3 illustrates an example of a target image 350 with a reference object 352. In the example illustrated in FIG. 3, a position marked with a rectangular bounding box 354 can be provided in response to user input and denotes a location for insertion of the insertion object. The user can be prompted to mark an object with a bounding box 356 that lies in the same background that the insertion object shadow will lie, which object can be referred to as the aforementioned reference object. In this example, the reference object in the target image can be a pillar with a statue affixed thereon to the left of the position marked with the rectangle. The reference object can be marked in a manner similar to the marketing of the insertion object shown and described with respect to FIG. 2.

Referring back to FIG. 1, at 40, a shadow of the reference object can be detected. The shadow of the reference object can be detected automatically and/or semi-automatically (e.g., with little to no input from the user). In the present example, several assumptions can be made to detect the shadow of the reference object. First, it can be assumed that the shadow of the reference object exists. Second, it can be assumed that the shadow of the reference object has a significant boundary with the reference object. Third, it can be assumed that the shadow of the reference object is sufficiently large to be detected. Detection of the shadow for the reference object can include, for example, determining a search area for the shadow of the reference object, and detecting candidate shadow pixels in the search area. Moreover, shadow pixels can be marked and shadow parameters for the shadow of the reference object can be extracted.

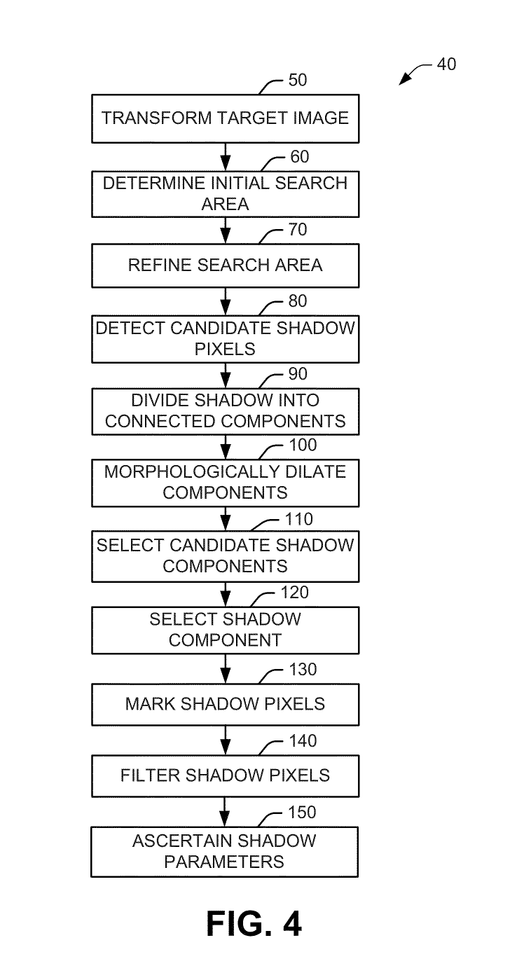

An example of a flowchart of a shadow detection method 40 is illustrated in FIG. 4. At 50, the target image can be transformed into a color space, such as CIELab color space, RGB color space, or the like. In one example, CIELab color space can be chosen to provide a distinct separation between lightness channels and color channels of the color space in the target image. Such a separation between lightness and color can be desirable since the shadow of the reference is roughly the same color of the background on which it lays, but its lightness level is lower. Stated differently, the shadow of the reference object is an area where the color is similar to its surrounding but the area's lightness is lower.

At 60, an initial search area for the shadow of the reference object can be determined. Initially, a small region of interest in the target image can be searched for a candidate for the shadow of the reference object. The region of interest is sufficiently small to avoid false detections that lead to incorrect results, but the region of interest should be large enough such that the region of interest contains not only the shadow of the reference object, but some of the background of the target image as well since the technique for detecting the shadow relies on the presumption that the shadow of the reference object lightness is smaller than the lightness of the color on which the shadow of the reference object lays. In view of the foregoing, the region of interest can be a rectangle that is three times wider than the reference object, and whose height is the sum of two factors, a third of the reference object's height and a tenth of the height of the reference object, wherein the region of interest is centered on the reference object.

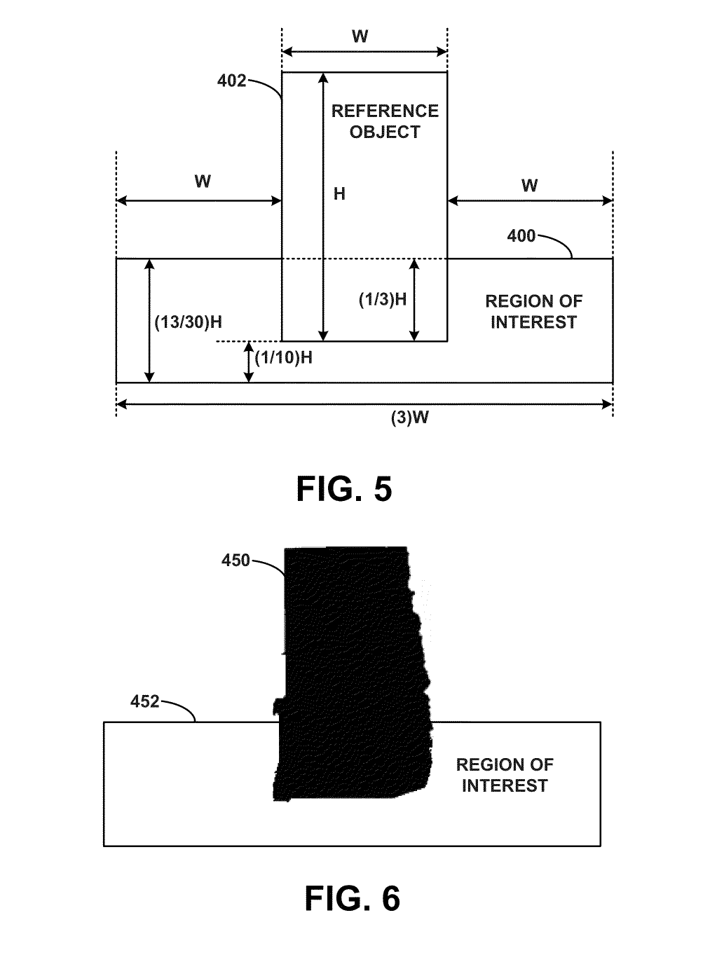

FIG. 5 illustrates an example of a region of interest 400 and its location within a target image relative to a reference object 402. In FIG. 5, the reference object 402 has a width denoted as ‘W’ and a height denoted as ‘H’. As is illustrated in FIG. 5, the width of the region of interest 400 extends the width of the reference object 402 from each opposite side boundary of the reference object 402, such that the total width of the region of interest 400 is about three times the width of the reference object, denoted in FIG. 5 as “(3)W.” Moreover, the region of interest 400 has a height equal to about one third (⅓) the height of the reference object 402 plus about one tenth ( 1/10) the height of the reference object 402, which is equal to thirteen thirtieths ( 13/30) of the height of the reference object 402, denoted in FIG. 5 as “( 13/30)H.”

Referring back to FIG. 4, at 70 the search area can be refined. For example, the region of interest 400 illustrated in FIG. 5 can be refined such that the region of interest border contains parts of the interior of the rectangle of the reference object 402, which increases the probability of finding the shadow of the reference object. FIG. 6 illustrates an example of the refinement of the region of interest 400 illustrated in FIG. 5. In FIG. 6, a silhouette of the reference object 450 is employed instead of a rectangle that outlines the reference object 402 as employed in FIG. 5. The silhouette of the reference object 450 can be generated, for example, from a silhouette segmentation technique. Such a silhouette segmentation technique could include, for example, edge detection. In FIG. 6, the region of interest 452 can be refined relative to the region of interest 400 illustrated in FIG. 5 to include area in the rectangle 402 that is not covered by the silhouette of the reference object 450. The refinement of the region of interest 452 increases the probability of finding the shadow of the reference object.

Referring back to FIG. 4, at 80, pixels can be detected as candidate shadow pixels. For example, pixels in the refined region of interest can be divided into two groups according to each pixel's lightness value such as using a k-means clustering technique. The k-means clustering technique can sort the candidate shadow pixels based on lightness of the candidate shadow pixels. By employing the k-means clustering technique, pixels within a calculated distance from a mean lightness can be set in a first group, while the pixels more than the calculated distance can be set in a second group. The k-means clustering technique can yield a label for each pixel indicating to which of the two groups of lightness value a given pixel belongs. The average values of the lightness for the two groups of lightness values can be determined, and the lower lightness of the two values can be assigned to a “shadow” group, while the higher lightness of the two values can be assigned to a “background” group. In other examples, other grouping techniques such as a Bayesian classification technique could be employed.

At 90, the set of pixels that belong to the shadow group can be divided into connected components. Each connected component can be implemented as a group of contiguously connected pixels that together make up a least a predetermined percentage of the region of interest (e.g., about 5%). Each component can be processed to determine if the pixels of a given component can in fact be shadow pixels. The determination can be made by examining the color and/or lightness of the given pixel. A shadow pixel will have roughly the same color as its background, but a shadow pixel will have a lower lightness than a corresponding background pixel.

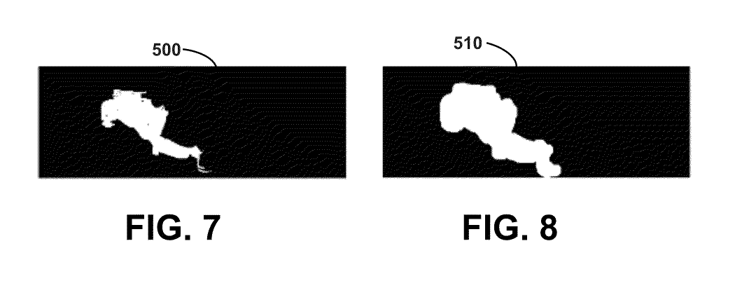

At 100, each of the connected components can be morphologically dilated to fill gaps and expand boundaries of the connected components. Thus, the morphological dilation can smooth the appearance of the connected components. FIGS. 7 and 8 illustrate two different images 500 and 510 that depict an example of a connected component before morphological dilation 500 and the same connected component after morphological dilation 510.

Referring back to FIG. 4, at 110, candidate shadow components can be selected from the connected components. To select the candidate shadow components from the connected components, each connected component can be processed to determine if a given component is a candidate shadow component. For example, each component contains original pixels alongside pixels that are in the boundary of an original component. The color and lightness of the original component pixels and the boundary pixels can be compared. If the color is similar and the lightness of the original pixels is much lower than the boundary pixels, then a given component can be labeled a candidate shadow component. For instance, for a given component to be considered to be a candidate shadow component, the given component should have colors of the components in the boundary (e.g., values of ‘a’ and ‘b’ channels of the color space) with a difference of about 5 units or less, and for a lightness (an ‘L’ channel of the color space), the difference should be about 20 units or more. Additionally, the components labeled as candidate shadow components can be filtered based on their size. For instance, a candidate shadow component smaller than about 3.5% the number of pixels in the refined region of interest can be filtered out and labeled as a non-shadow component.

At 120, a single shadow component can be selected from the candidate shadow components. To select the shadow component, it can be presumed that the reference object shares a long boundary segment with the shadow of the reference object. Accordingly, each component labeled as a candidate shadow component can be sorted according to a number of pixels that are in a boundary of a candidate shadow component and the reference object, and the candidate shadow component with the largest boundary can be selected and labeled as the shadow component. Moreover, in situations where two or more candidate shadow components have a substantially equally sized boundary, the candidate shadow component that has a color most similar to the color of the background can selected and labeled as the shadow component. Still further, in situations where two or more candidate shadow components have colors equally similar to the background, the candidate shadow component with the largest difference in lightness from the background can be selected and labeled as the shadow candidate component. Yet further, in situations where two or more candidate components have substantially equal differences in lightness with the background, a candidate shadow component can be selected randomly and labeled as the shadow component.

At 130, a shadow of the reference object can be marked. To ensure the selected shadow component has not been cropped by region of interest boundaries, a median and standard deviation of pixels belonging to the shadow component can be determined for each channel in the transformed color space (e.g., the ‘a’, ‘b’ and ‘L’ channels). The determination can result in six values, namely median_{L}, std_{L}, medianₐ, stdₐ, median_{b}, and std_{b} wherein:

median_{L} represents the median of channel ‘L’ of the transformed color space;

std_{L} represents the standard deviation of channel ‘L’ of the transformed color space;

medianₐ represents the median of channel ‘a’ of the transformed color space;

stdₐ represents the standard deviation of channel ‘a’ of the transformed color space;

median_{b} represents the median of channel ‘b’ of the transformed color space; and

std_{b} represents the standard deviation of channel ‘b’ of the transformed color space.

Pixels of the shadow of the reference object can be marked by searching the entire target image for pixels in the color space with ‘L’, ‘a’ and ‘b’ channel values that are in a range defined by the interval of [median-std, median+std] using corresponding values for each channel. The resultant marked pixels yields most of the actual shadow of the reference object. Accordingly, an estimated location of the shadow of the reference object can be determined based on the location within the target image of the marked pixels.

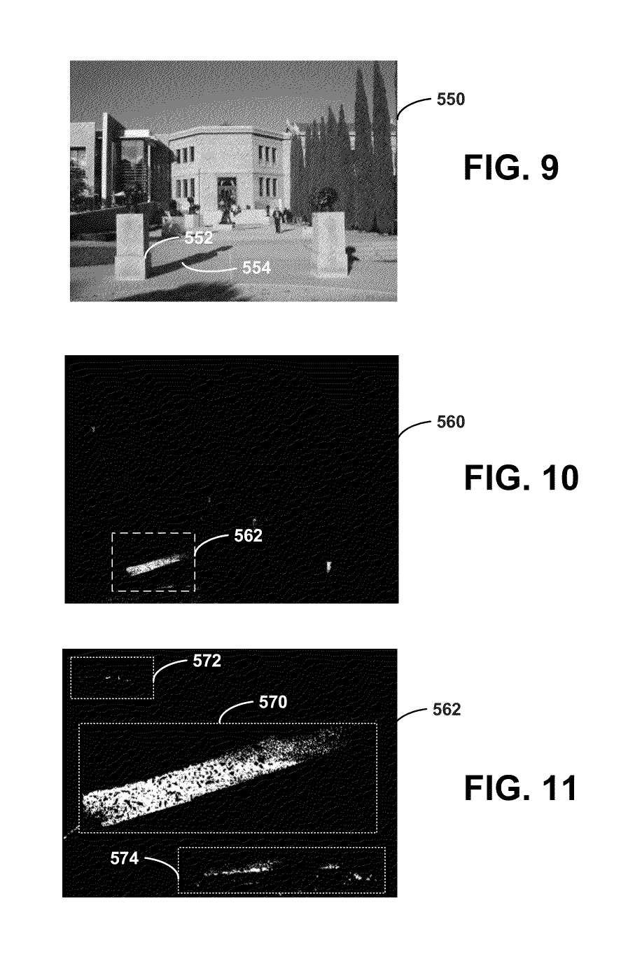

At 140, a false detection of the pixels in the shadow of the reference object can be filtered. FIGS. 9-11 illustrate an example of filtering shadow pixels. FIG. 9 illustrates an example of an original copy of the target image 550. FIG. 10 illustrates a shadow mask 560 of the target image 550 illustrated in FIG. 9. The shadow mask 560 can represent a version of the target image 550 illustrated in FIG. 9, wherein the all (or nearly all) of the target image 550 except for the marked pixels has been removed and/or masked. The shadow mask 560 includes a bounding box 562 formed based on the estimated location of the shadow of the reference object. FIG. 11 illustrates a zoomed in version of the bounding 562 box illustrated in FIG. 10. In FIG. 11, pixels within a dotted box 570 are connected to a main component (e.g., a component with a largest number of contiguously connected pixels). Further, other pixels, such as pixels in dotted boxes 572 and 574 can be filtered out since such pixels are not connected to the main component within a dotted box 574. The pixels within the dotted box 570 can correspond to a detected shadow.

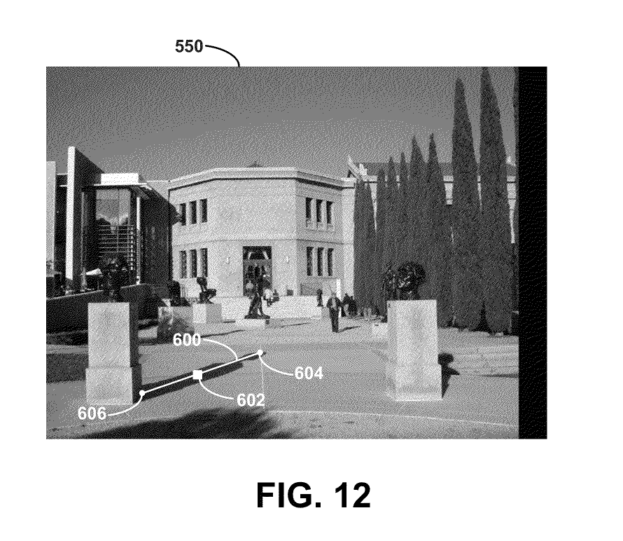

Referring back to FIG. 4, at 150, shadow parameters for the shadow of the reference object can be ascertained based on the detected shadow. The parameters can include the direction and orientation of the shadow of the reference object with respect to the reference object. To ascertain parameters, “holes” in the detected shadow can be filled using a morphological operation to generate a white area representing the shadow of the object. Moreover, a principal component analysis (PCA) technique can be applied to the white area that defines the shadow of the object, and a principal direction of the shadow can be ascertained. Additionally, a location of the shadow of the reference object in respect to the location of the reference object can be determined based on the PCA of the white area. In the example illustrated in FIG. 9, a reference object 552 (the front left pillar) includes a shadow 554 of the reference object 552 that points in the top-right direction, at about a 30° angle with respect to a direction of the horizon, and the shadow 554 of the reference object 552 is located to the right of the reference object 562. FIG. 12 illustrates an example of the target image 550 illustrated in FIG. 9, wherein a shadow location has been computed for the reference object 352 marked in FIG. 3. In FIG. 12, the computed location of the shadow is denoted with a line 600. For example, the line 600 includes a square at 602 denoting a center of the shadow and circles at 604 and 606 denoting shadow boundary points.

Referring back to FIG. 1, at 160, the insertion object can be inserted at the destination area marked in action 25. During the insertion of the insertion object, the insertion object can be rescaled from its original size in the source image by adjusting the ratio between heights of the destination area and the object.

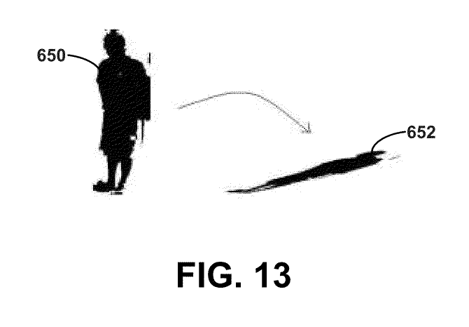

At 170, the shadow of the insertion object can be formed. The shadow of the insertion object can be formed automatically and/or semi-automatically (e.g., with little to no input from the user). Moreover, the shadow of the insertion object can have a natural appearance. To form the shadow, a silhouette of the insertion object can be generated. The silhouette of the insertion object can be formed by employing silhouette segmentation techniques, including edge detection. The silhouette of the insertion object can be transformed with an affine transformation. FIG. 13 illustrates an example of transforming the silhouette 650 of the insertion object 310 selected in FIG. 2. The affine transformation of the silhouette 650 of the insertion object can include, for example, a transformation that carries straight lines into straight lines and parallel lines into parallel lines, but may alter the distance between points and angles between lines. The affine transformation of the silhouette 650 can rotate and project the silhouette onto a surface, such as the target image to form a shadow 652 for the insertion object. Accordingly, affine transformation of the silhouette 650 can change an orientation of the silhouette. To execute the affine transformation, three source points of the silhouette 650 of the insertion object can be mapped onto three target points. The affine transformation can presume that after the transformation the bottom two target points stay fixed, such that affine transformation is determined only at the third target point. The ratio between the height of the reference object and shadow of the reference object is used for scaling a distance between the third target point and the two bottom target points. The orientation of the reference object with respect to the shadow of the reference object is known, as well as the direction of the shadow of the reference object, such that a rotation of a scaled third source point of the silhouette 650 of the insertion object can be determined.

Referring back to FIG. 1, at 180, the shadow of the insertion object can be inserted into the target image. Insertion of the shadow of the insertion object can include, for example, determining a transparency of the shadow of the insertion object and determining a shadow gradient for the shadow of the insertion object.

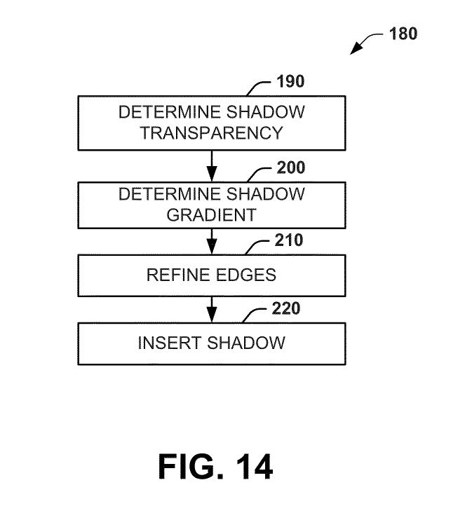

An example of a flowchart of a showdown insertion method 180 is illustrated in FIG. 14. At 190, an appropriate transparency of the shadow of the insertion object can be determined. The level of transparency of the shadow of the insertion object can be controlled by an opacity level of the shadow of the reference object. A lit area within in a rectangle (or other shape) that marks the shadow of the reference object can be analyzed in order to find an opacity level of the shadow of the reference object such as show by Equation 1.

α̅=(α_{R},α_{G},α_{B}) wherein: Equation 1

α̅ represents the aggregate opacity level;

α_{R} represents the opacity level of the red channel (‘R’ channel) in the color space of the target image;

α_{G} represents the opacity level of the green channel (‘G’ channel) in the color space of the target image; and

α_{B} represents the opacity level of the blue channel (‘B’ channel) in the color space of the target image.

As an example, the opacity level of a given channel can be determined with Equation 2.

$${α}_{X} = 1 - \frac{{〈 Shadow 〉}_{X}}{{〈 Lit 〉}_{X}} wherein \text{:} \qquad Equation 2$$

<Shadow>_{X} represents an average of the given channel ‘X’ (e.g., the ‘R’, ‘G’ or ‘B’ channel) in the shadow of the reference object; and

<Lit>_{X} represents an average of the given channel ‘X’ in the lit area of the reference object.

Upon calculation of the opacity level for each channel of the shadow of the reference object, values of pixels for the shadow of the insertion object can be calculated such as show by Equation 3.

Shadow_{X}=1−Lit_{X}(1−αₓ) wherein: Equation 3

Shadow_{X} represents values of the shadow pixels for a given channel ‘X’ (e.g., the ‘R’, ‘G’ or ‘B’ channel) in the shadow of the insertion object;

Lit_{X} represents an original value of pixels for the given channel ‘X’ in the shadow of the insertion object; and

αₓ represents an opacity level in the reference object for the given channel ‘X’.

At 200, a shadow gradient for the shadow of the reference object can be determined. A shadow can appear darkest at a contact point with an object, and becomes brighter the further away it is from that point. Thus, the shadow gradient for the shadow of the insertion object can be determined by increasing the opacity level at the base of the shadow, and linearly or non-linearly decreasing the opacity level as the distance from the base increases.

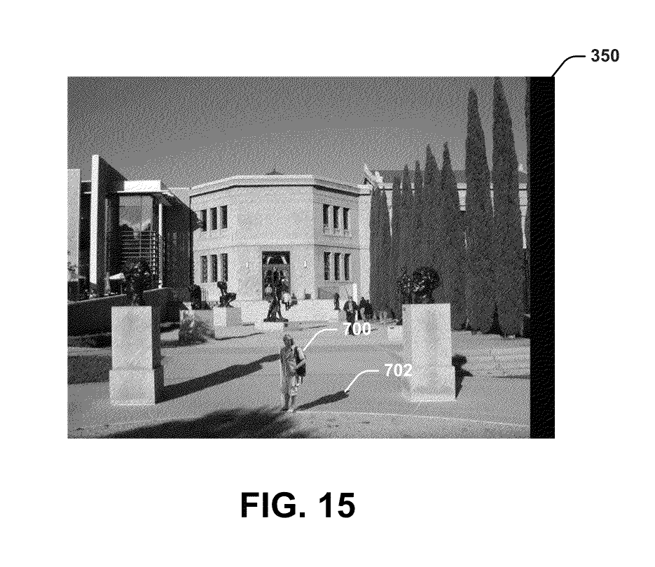

At 210, edges of the shadow of the insertion object can be refined to make the shadow of the insertion object appear more natural. For example, the refining of the shadow of the insertion object can include convolving the shadow of the insertion object with a small Gaussian kernel. Moreover, to further improve the appearance of the shadow of the insertion object, particularly in situations where the background of the shadow of the insertion object is textured, a dithering noise can be added to pixels near edges of the shadow of the insertion object. As an example, the edges of the shadow of the insertion object can be ascertained by employing morphological erosion and dilation techniques. The morphological erosion and dilation can turn some pixels that are at or above a given lightness level and are within a small range of these edges into shadow pixels with an appropriate opacity level. Additionally or alternatively, in some examples of the morphological erosion and dilation, a lightness of some of the shadow pixels of the shadow of the insertion object can be increased to at least the given lightness level. At 220, the shadow can be inserted into the target image. FIG. 15 illustrates an example of the target image 350 illustrated in FIG. 3 with insertion object 700 inserted with the shadow 702 formed for the insertion object.

Referring back to FIG. 1, by employing the method 10, the insertion object can be copied and/or cut from the source image and inserted into the target image, with minimal input from the user (e.g., semi-automatically and/or automatically). For instance, the user needs only to identify the insertion object, the reference object and the area for insertion in the target image, and in response, calculations for forming and inserting a shadow for the insertion object can be executed automatically without additional input from the user. That is, the method 10 can reduce and/or obviate the need for the user to adjust the position and or the lightness of the generated shadow for the insertion object. Moreover, the resultant image will have a shadow generated for the insertion object that appears natural, thus making it appear that the insertion object was within the target image originally, rather than being added later. The method 10 can also be implemented in two dimensional images that represent three dimensional spaces (e.g., photographs) wherein there is no knowledge of three dimensional parameters of the insertion object. Moreover, by employing the method 10, no knowledge of an illumination direction is needed to form the shadow for the insertion object.

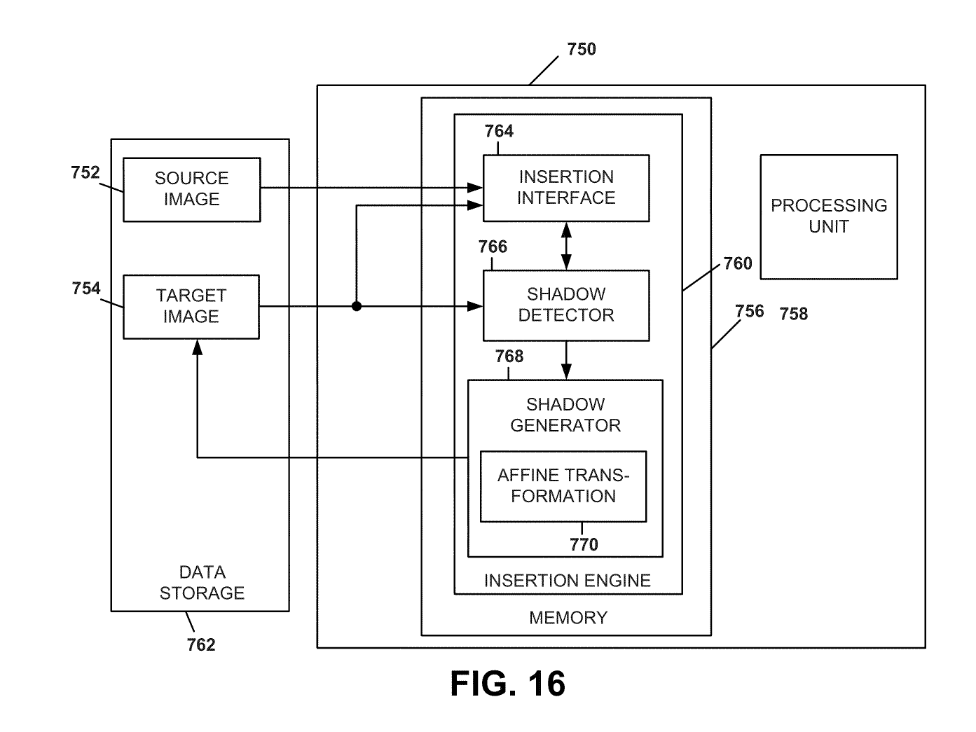

FIG. 16 illustrates an example of a computer system 750 for inserting an object from a source image 752 into a target image 754, which object can be referred to as an insertion object. The computer system 750 can include a memory 756 for storing machine readable instructions. The memory 756 can be implemented, for example, as volatile or non-volatile random access memory (RAM), programmable logic, or the like. The computer system 750 can also include a processing unit 758 that can access the memory 756 and executes the machine readable instructions. The processing unit 758 can be implemented, for example, as a processing core.

By way of example, the machine readable instructions can include an insertion engine 760 that can be employed to manipulate the source image 752 and/or the target image 754. The source image 752 and the target image 754 can be implemented as image files, such as JPEG or bitmap files. The source image 752 and the target image 754 can be stored, for example, in a data storage 762, which data storage 762 could be implemented as a computer readable medium, such as a hard disk, a hard disk array, a solid state drive, etc. In the example of FIG. 16, the data storage 762 is illustrated as being a separate structure from the computer system 750. However, the data storage 762 can be integrated with the computer system 750. The source image 752 and the target image 754 can be the same or different formats. It is to be noted that in some examples, the source image 752 and the target image 754 can be the same file, such that the insertion object can be extracted from the target image 754.

In one example, the insertion engine 760 can include an insertion interface 764 to provide a GUI to a user for inserting an insertion object from the source image 752 into the target image 754. The GUI can provide a mechanism to select the insertion object from the source image 752. The insertion object can include, for example, a portion of the source image 752.

Moreover, the insertion interface 764 can provide the user with an image of the target image 754, wherein the user can mark a reference object in the target image 754. A shadow detector 766 of the insertion engine 760 can detect a shadow of the reference object in a manner described herein. Additionally, the insertion interface 764 can allow the user to mark a destination area for the insertion object in the target image 754. A shadow generator 768 of the insertion engine 760 can form a shadow for the insertion object based on the detected shadow for the reference object in a manner described herein. In one example, the shadow generator 768 can include an affine transformation 770 that employs an affine transformation technique to change an orientation of a silhouette of the insertion object, such as described herein. The shadow generator 768 can insert the insertion object into the target image 754 such that the insertion object can appear to have been originally in the target image 754. The insertion engine 760 can be employed in a variety of environments. For instance, the insertion engine 760 can be employed in entertainment (e.g. filming), photography and/or art.

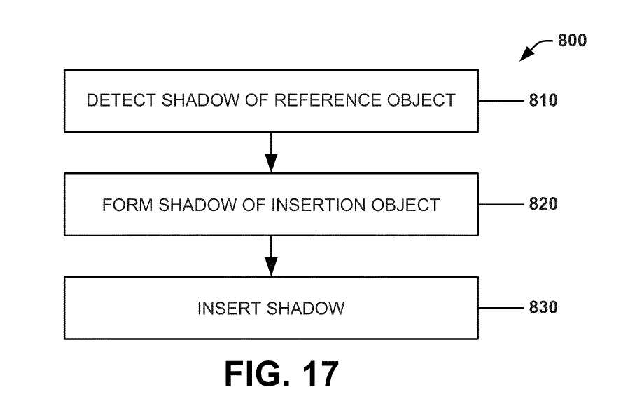

FIG. 17 illustrates another flowchart of an example method 800 for inserting an insertion object into a target image. At 810, a shadow for a reference object in the target image can be detected (e.g., by the shadow detector 766 illustrated in FIG. 16). At 820, a shadow for the insertion object can be formed based on the detected shadow for the reference object (e.g., by the shadow generator 768 and/or the affine transformation 770 illustrated in FIG. 16). At 830, the shadow for the insertion object can be inserted into the target image (e.g., by the shadow generator 768 illustrated in FIG. 16).

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. As used herein, the term “includes” means includes but not limited to, the term “including” means including but not limited to. The term “based on” means based at least in part on.

What is claimed is:

1. A method comprising:
detecting a shadow for a reference object in a target image in response to user input marking the reference object;
forming a shadow for an insertion object that is being inserted into the target image based on the detected shadow for the reference object; and
inserting the shadow for the insertion object into the target image.

2. The method of claim 1, further comprising inserting the insertion object into the target image.

3. The method of claim 2, wherein an area in the target image for insertion of the insertion object is marked in response to user input.

4. The method of claim 1, wherein the detecting comprises:
determining a search area for the shadow of the reference object; and
detecting candidate shadow pixels for the shadow of the reference object within the search area.

5. The method of claim 4, wherein the detecting further comprises:
dividing the shadow of the reference object into connected components;
morphologically dilating the connected components; and
selecting a shadow component from the connected components.

6. The method of claim 5, wherein the detecting further comprises:
marking shadow pixels within the selected shadow component; and
ascertaining shadow parameters from the selected shadow component.

7. The method of claim 1, wherein the inserting further comprises determining a transparency for the shadow of the insertion object, wherein the transparency is based on an opacity level calculated for the shadow of the reference object.

8. The method of claim 7, wherein the inserting further comprises:
determining a shadow gradient for the insertion object; and
refining edges of the shadow for the insertion object, thereby improving an appearance of the shadow of the insertion object.

9. The method of claim 1, wherein the shadow for the insertion object is formed by:
generating a silhouette of the insertion object; and
transforming the silhouette with an affine transformation to change an orientation of the silhouette.

10. An image insertion system comprising:
a memory to store machine readable instructions; and
a processing unit to access the memory and execute the machine readable instructions, the machine readable instructions comprising:
an insertion engine to insert an insertion object from a source image into a target image; and
a shadow generator to generate and insert a shadow for the insertion object into the target image based on a shadow for a reference object detected in the target image.

11. The image insertion system of claim 10, further comprising an insertion interface to select the insertion object from the source image in response to user input, and to select an area in the target image for insertion of the insertion object in response to user input.

12. The image insertion system of claim 11, further comprising a shadow generator to determine a transparency for the shadow of the insertion object based on an opacity level calculated for the shadow detected for the reference object.

13. The image insertion system of claim 10, further comprising an affine transformation to generate the shadow for the insertion object based on a silhouette of the insertion object.

14. A computer readable medium having computer readable instructions comprising:
an insertion engine to insert an insertion object from a source image into a target image, the insertion image comprising:
an insertion interface to:
select the insertion object from the source image in response to user input; and
select a destination area in the target image to insert the insertion object in response to user input;
a shadow detector to detect a shadow of the reference object, wherein the shadow detector is further to:
transform the target image into a color space;
determine a search area for the shadow of the reference object;
refine the search area;
detect candidate shadow pixels within the search area;
divide the shadow of the reference object into connected components;
morphologically dilate the connected components;
select candidate shadow components from the connected components;
select a shadow component from the candidate shadow components;
mark shadow pixels in the shadow component;
filter the pixels in the shadow component; and
ascertain shadow parameters for the detected shadow of the reference object;
a shadow generator to form a shadow for the insertion object and insert the shadow of the insertion object into the target image, wherein the shadow generator is to:
determine a shadow transparency for the shadow of the insertion object, the transparency being based on an opacity level calculated for the shadow detected for the reference object;
determine a shadow gradient for the shadow of the insertion object; and
refine edges of the shadow of the insertion object.

15. The computer readable medium of claim 14, wherein the shadow generator comprises an affine transformation to change an orientation of a silhouette of the insertion object.
